(19) United States
(12) Patent Application Publication
(10) Pub. No.: US 2023/0147570 A1
(43) Pub. Date: May 11, 2023

(54) PATROL ROUTE GENERATION APPARATUS, PATROL ROUTE GENERATION METHOD, AND COMPUTER-READABLE RECORDING MEDIUM

(71) Applicant: NEC Corporation, Minato-ku, Tokyo (JP)

(72) Inventors: Yasuyuki NOBEOKA, Tokyo (JP); Kana YAMADA, Tokyo (JP)

(73) Assignee: NEC Corporation, Minato-ku, Tokyo (JP)

(21) Appl. No.: 17/914,553

(22) PCT Filed: Mar. 30, 2020
(86) PCT No.: PCT/JP2020/014458

§ 371 Date: Sep. 26, 2022

(51) Int. Cl. G01C 21/36; G01C 21/34

(52) U.S. Cl. CPC G01C 21/3617; G01C 21/3446; G01C 21/3691

(57) ABSTRACT

A patrol route generation apparatus for generating a patrol route for an inspector who checks abandoned object, includes: a patrol route estimation unit that estimates a patrol route for the inspector in the past, based on a location information indicating a place where the abandoned object was checked in the past and a time information indicating time when the abandoned object was checked in the past, a patrol route generation unit that generates a patrol route in a preset area and in a preset time zone, based the estimated patrol route for the inspector in the past, the location information indicating the place where the abandoned object was checked in the past and the time information indicating the time when the abandoned object was checked in the past.

### TECHNICAL FIELD

The present invention relates to a patrol route generation apparatus and a patrol route generation method for generating a patrol route in a checking work of an illegally abandoned object, for example, an abandoned vehicle, and further relates to a computer-readable recording medium on which a program for realizing these is recorded.

### BACKGROUND ART

Illegally parked vehicles block passage of pedestrians, bicycles, etc., and causes traffic accidents and traffic congestion. Furthermore, illegally parked vehicles may hinder passage of emergency vehicles such as police cars and ambulances in the event of an incident, accident, disaster, or the like. For this reason, in recent years, the National Police Agency has entrusted task of checking illegally parked and abandoned vehicles to private corporations in order to promote the eradication of illegal parking.

Incidentally, usually, in the task of checking abandoned vehicles, when police station designates area in charge to inspectors, the inspectors checks the illegally parked and abandoned vehicles by patrolling the designated area. At this time, if the patrol is carried out unplanned, the inspectors cannot efficiently check the abandoned vehicle, which makes it difficult to eradicate illegal parking.

In order to solve such problems, Patent Document 1 discloses an apparatus that automatically generates patrol plan for inspectors. Specifically, the apparatus disclosed in Patent Document 1 first predict a number of crackdowns per hour in each area on patrol date, based on actual number of crackdowns on illegal parking in each area for each time zone. Next, the apparatus disclosed in Patent Document 1 selects an area with the largest predicted value for each time zone period based on the predicted number of crackdowns per hour in each area, sets the selected area as a patrol target for that time zone, and generates a patrol plan. According to the apparatus disclosed in Patent Document 1, the inspectors can patrol areas where many abandoned vehicles are expected for each time zone.

### LIST OF RELATED ART DOCUMENTS

### Patent Document

Patent Document 1: Japanese Patent Laid-Open Publication No. 2007-233742

### SUMMARY OF INVENTION

### Problems to be Solved by the Invention

However, the apparatus disclosed in Patent Document 1 has only a function of selecting an area to be patrolled for each time zone and does not consider a route from area to area. For this reason, if the area selected in one time zone and the area selected in the next time zone are separated from each other, an efficiency of the patrol is reduced and burden on the inspector is increased accordingly.

An example of an object of the invention is to provide a patrol route generation apparatus, a patrol route generation method, and a computer-readable recording medium that eliminate the above-described problems and that formulate a patrol route for checking an abandoned object.

### Means for Solving the Problems

In order to achieve the above-described object, a patrol route generation apparatus according to an example aspect of the invention is an apparatus for generating a patrol route for an inspector who checks abandoned object, and includes:

a patrol route estimation unit configured to estimate a patrol route for the inspector in the past, based on a location information indicating a place where the abandoned object was checked in the past and a time information indicating time when the abandoned object was checked in the past,

a patrol route generation unit configured to generate a patrol route in a preset area and in a preset time zone, based the estimated patrol route for the inspector in the past, the location information indicating the place where the abandoned object was checked in the past and the time information indicating the time when the abandoned object was checked in the past.

In addition, in order to achieve the above-described object, a patrol route generation method according to an example aspect of the invention is a method for generating a patrol route for an inspector who checks abandoned object, and includes:

a patrol route estimation step of estimating a patrol route for the inspector in the past, based on a location information indicating a place where the abandoned object was checked in the past and a time information indicating time when the abandoned object was checked in the past,

a patrol route generation step of generating a patrol route in a preset area and in a preset time zone, based the estimated patrol route for the inspector in the past, the location information indicating the place where the abandoned object was checked in the past and the time information indicating the time when the abandoned object was checked in the past.

Furthermore, in order to achieve the above-described object, a computer readable recording medium according to an example aspect of the invention is a computer readable recording medium that includes recorded thereon a program for generating a patrol route for an inspector who checks abandoned object by means of a computer,

the program including instructions that cause the computer to carry out

a patrol route estimation step of estimating a patrol route for the inspector in the past, based on a location information indicating a place where the abandoned object was checked in the past and a time information indicating time when the abandoned object was checked in the past,

a patrol route generation step of generating a patrol route in a preset area and in a preset time zone, based the estimated patrol route for the inspector in the past, the location information indicating the place where the abandoned object was checked in the past and the time information indicating the time when the abandoned object was checked in the past.

### Advantageous Effects of the Invention

As described above, according to the present invention, it is possible to formulate a patrol route for checking an abandoned object.

### BRIEF DESCRIPTION OF THE DRAWINGS

FIG. 1 is a block diagram illustrating a schematic configuration of a patrol route generation apparatus according to an example embodiment.

FIG. 2 is a block diagram specifically illustrating the configuration of the patrol route generation apparatus according to the example embodiment.

FIG. 3 is a diagram illustrating an example of information stored in the data storage unit in the example embodiment.

FIG. 4 is a diagram illustrating an example of a patrol route estimated in the example embodiment.

FIG. 5 is a diagram illustrating a concept of the machine learning model used in the example embodiment.

FIG. 6 is a flow diagram illustrating an operation of the patrol route generation apparatus according to the example embodiment at the machine learning model construction process.

FIG. 7 is a flow diagram illustrating an operation of the patrol route generation apparatus according to the example embodiment at the patrol route generating.

FIG. 8 is a block diagram illustrating an example of a computer that realizes the patrol route generation apparatus according to the example embodiment.

### EXAMPLE EMBODIMENT

### Example Embodiment

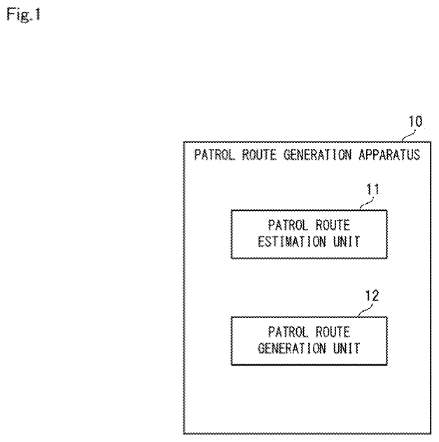

The following describes a patrol route generation apparatus, a patrol route generation method, and a program according to the example embodiment with reference to FIGS. 1 to 7.

[Apparatus Configuration]

First, the schematic configuration of the patrol route generation apparatus in the example embodiment will be described with reference to FIG. 1. FIG. 1 is a block diagram illustrating a schematic configuration of the patrol route generation apparatus according to an example embodiment.

The patrol route generation apparatus 10 according to the example embodiment illustrated in FIG. 1 is an apparatus for generating a patrol route for an inspector who checks an abandoned object. As illustrated in FIG. 1, the patrol route generation apparatus 10 includes a patrol route estimation unit 11 and a patrol route generation unit 12.

In this configuration, the patrol route estimation unit 11 estimates a patrol route for the inspector in the past, based on a location information indicating a place where the abandoned object was checked in the past and a time information indicating time when the abandoned object was checked in the past.

The patrol route generation unit 12 generates the patrol route in a preset area and in the preset time zone, based the estimated patrol route for the inspector in the past, the location information indicating the place where the abandoned object was checked in the past and the time information indicating the time when the abandoned object was checked in the past.

As described above, in the example embodiment, the patrol route generation apparatus 10 generates the route to be patrolled by the inspector for the preset area and the preset time zone from the information of the abandoned object checked in the past. According to the example embodiment, it is possible to formulate the patrol route in the checking work of abandoned object.

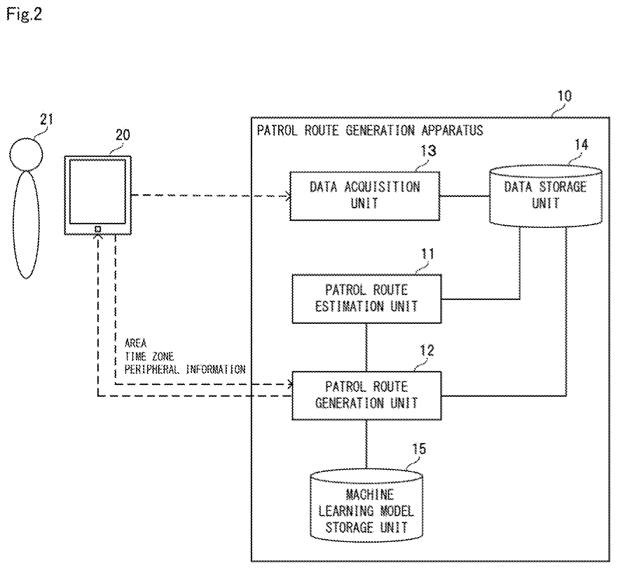

Next, the configuration and function of the patrol route generation apparatus according to the example embodiment will be described more specifically with reference to FIGS. 2 to 5. FIG. 2 is a block diagram specifically illustrating the configuration of the patrol route generation apparatus according to the example embodiment.

As illustrated in FIG. 2, in the example embodiment, the patrol route generation apparatus 10 is connected to the terminal device 20 via a network so as to be capable of data communication. The terminal device 20 is a terminal device used by the inspector 21, such as a smartphone or a tablet-type terminal device.

Further, in the example embodiment, examples of the abandoned object include an abandoned vehicle parked illegally, garbage illegally abandoned (oversized garbage, combustible garbage, etc.), and a suspicious object left unattended. In the following, an example in which the abandoned object is an abandoned vehicle will be described.

When the inspector 21 performs the checking work of the abandoned vehicle, the inspector 21 inputs to the terminal device 20 the location where the abandoned vehicle is checked and the time when the abandoned vehicle is checked. The input of the location may be performed by designating a point on a map displayed on a screen of the terminal device or may be performed by inputting a address. Further, the time may be input by selecting a tab prepared in advance, or by manually inputting the time.

When the inspector 21 completes the input, the terminal device 20 adds an identifier (ID) for specifying the inspector 21 to the location information indicating the place where the abandoned vehicle is checked and the time information indicating the time when the abandoned vehicle is checked. The terminal device 20 transmits this information with the identifier to the patrol route generation apparatus 10.

In case that the terminal device 20 is provided with a GPS (Global Positioning System) receiver and a clock, the terminal device 20 may accept only an input indicating that the checking work has been performed from the inspector 21. In this case, when the input is made, the terminal device 20 transmits the location information indicating the position positioned by the GPS receiver at that time and the time information indicating the time at that time.

As illustrated in FIG. 2, in the example embodiment, the patrol route generation apparatus 10 includes a data acquisition unit 13, a data storage unit 14, and a machine learning model storage unit 15, in addition to the patrol route estimation unit 11 and the patrol route generation unit 12 described above.

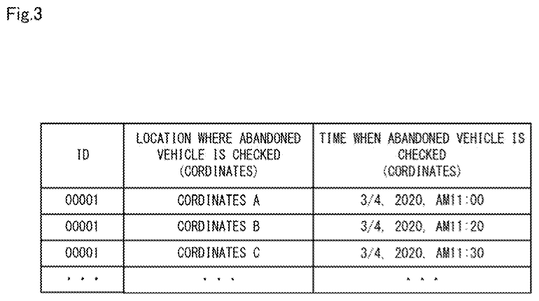

When the location information and the time information with the ID are transmitted from the terminal device 20, the data acquisition unit 13 acquires this information and stores the acquired information in the data storage unit 14. FIG. 3 is a diagram illustrating an example of information stored in the data storage unit in the example embodiment. As illustrated in FIG. 3, in the example embodiment, the information acquired when the inspector 21 has performed the checking work of the abandoned vehicle in the past is stored in the data storage unit 14.

In the example embodiment, the patrol route estimation unit 11 estimates the patrol route for each inspector 21 in the past by using the location information and the time information stored in the data storage unit 14. Specifically, the patrol route estimation unit 11 first acquires the location information and the time information associated with the same ID on the same day, and plot the place(coordinates) specified by the location information on the electronic map prepared in advance.

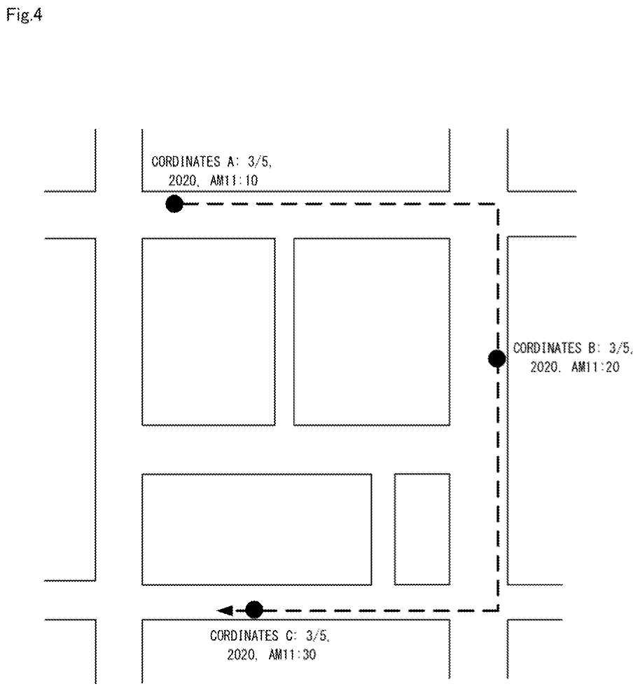

Then, as illustrated in FIG. 4, the patrol route estimation unit 11 traces all the plotted locations in order from the earliest time specified by the time information, for example, giving priority to the road that is a parking prohibited area, and estimates the patrol route. FIG. 4 is a diagram illustrating an example of an estimated patrol route in the example embodiment.

In the example embodiment, the patrol route generation unit 12 generates the patrol route by inputting an area and a time zone for which the patrol route is to be generated into a machine learning model.

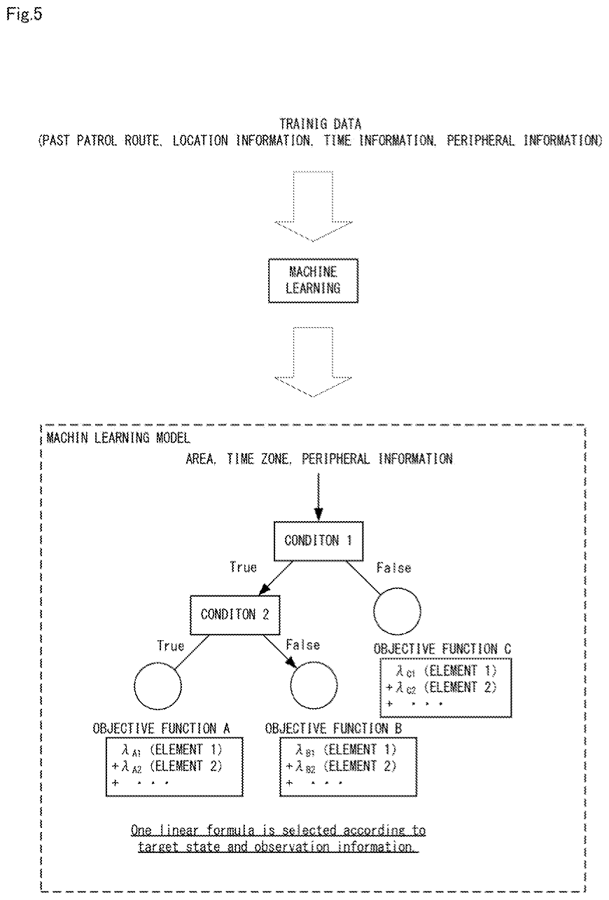

The machine learning model is a model that expresses the relationship between the patrol route for the inspector in the past estimated by the patrol route estimation unit 11, the location information indicating the place where the abandoned object was checked in the past and the time information indicating the time when the abandoned vehicle was checked in the past, by a branch expression and an objective function. FIG. 5 is a diagram illustrating the concept of the machine learning model used in the example embodiment. In the example of FIG. 5, an optimization index is learned so that it can be understood in what case and what is emphasized.

In the example embodiment, the patrol route generation unit 12 constructs the machine learning model described above, using the patrol route for the inspector 21 in the past estimated by the patrol route estimation unit 11, the location information and time information stored in the data storage unit 14, as training data to build. The patrol route generation unit 12 stores the branch expression and the objective function constituting the constructed machine learning model in the data storage unit 14.

In the example embodiment, in the above-mentioned relationship, the machine learning model may further include at least one of weather information indicating weather of place where the abandoned vehicle was checked in the past, road conditions information indicating condition of road of the place, and event information specifying an event that taking place at the place. Hereinafter, these pieces of information will be collectively referred to as “peripheral information”. In this case, the patrol route generation unit 12 also uses past peripheral information as training data. In the example embodiment, the past peripheral information is stored in the data storage unit 14 in advance.

Further, in this case, the patrol route generation unit 12 inputs at least one of the latest weather information, the latest road conditions information, and the latest event information to the machine learning model in addition to the area and time zone for which the patrol route is to be generated and generates a patrol route.

Here, the machine learning model illustrated in FIG. 5 will be specifically described. First, it is assumed that an electronic map in which the main points to be checked by the inspector 21 are registered is prepared, and an upper limit of the number of checking for each point is set in advance on the electronic map. Further, it is assumed that the patrol route for the inspector 21 in the past, the past location information, the past time information, and the past peripheral information are used as the training data. In this case, in machine learning for constructing the machine learning model, a combination of points that maximizes the number of points that can be checked is learned within the range of the upper limit of the number of checking for each point.

[Apparatus Operations]

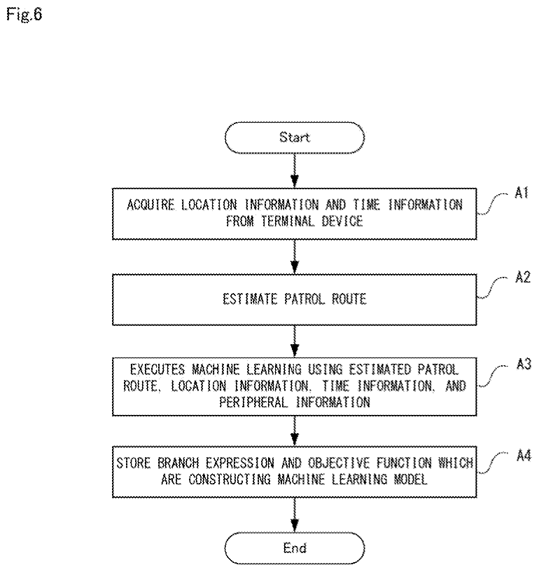

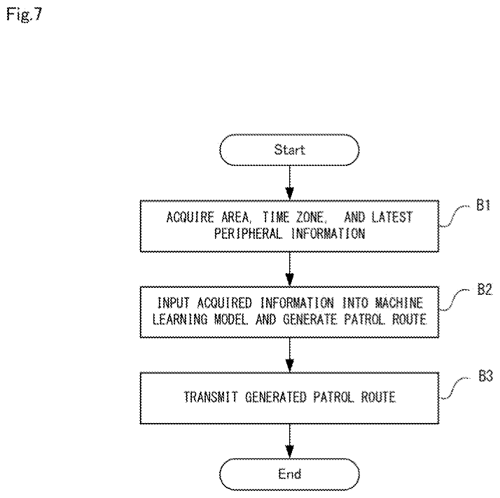

Next, the patrol route generation apparatus 10 according to the example embodiment will be described using FIGS. 6 and 7. In the following description, FIGS. 1 to 5 will be referred to as appropriate. Furthermore, in the example embodiment, the patrol route generation method is implemented by operating the patrol route generation apparatus 10. Therefore, the following description of the operation of the patrol route generation apparatus 10 applies to the patrol route generation method according to the example embodiment.

First, the process up to the construction of the machine learning model will be described with reference to FIG. 6. FIG. 6 is a flow diagram illustrating an operation of the patrol route generation apparatus according to the example embodiment at the machine learning model construction process.

As a premise, the inspector 21 performs the checking work of the abandoned vehicle using the terminal device 20, and then, the terminal device 20 transmits the location information and the time information with the ID of the inspector 21 to the patrol route generation apparatus 10.

And then, as illustrated in FIG. 6, in the patrol route generation apparatus 10, the data acquisition unit 13 acquires the transmitted location information and the time information, and stores the acquired information in the data storage unit 14 (Step A1). A1).

Next, the patrol route estimation unit 11 estimates the patrol route for each inspector 21 in the past using the location information and the time information stored in the data storage unit 14 (Step A2).

Next, the patrol route generation unit 12 executes machine learning by using the estimated patrol route for the observer 21 in the past in step A2, the location information, the time information, and the peripheral information stored in the data storage unit 14 (Step A3). By executing Step A3, the machine learning model which indicates the relationship between the patrol route for inspector 21, the location information, the time information, and peripheral information by the branch expression and the objective function is constructed.

Next, the patrol route generation unit 12 stores the branch expression and the objective function of the machine learning model constructed by the machine learning in Step A3 in the machine learning model storage unit 15 (Step A4).

Subsequently, the process of generating the patrol route using the machine learning model will be described with reference to FIG. 7. FIG. 7 is a flow diagram illustrating an operation of the patrol route generation apparatus according to the example embodiment at the patrol route generating.

As a premise, the inspector 21 inputs the area to be patrolled, the time zone, and the latest peripheral information in the terminal device 20. As a result, the terminal device 20 transmits each input information to the patrol route generation apparatus 10.

And then, as illustrated in FIG. 7, in the patrol route generation apparatus 10, the patrol route generation unit 12 acquires the area to be patrolled, the time zone, and the latest peripheral information transmitted from the terminal device 20. (Step B1).

Next, the patrol route generation unit 12 extracts the branch expression and the objective function from the machine learning model storage unit 15, constructs the machine learning model. The patrol route generation unit 12 inputs the information acquired in step B1 into the constructed machine learning model and generates the patrol route (Step B2).

Next, the patrol route generation unit 12 transmits the generated patrol route to the terminal device 20 that is the transmission source of the information acquired in Step B1 (Step B3). As a result, the generated patrol route is displayed on the screen of the terminal device 20. Therefore, the inspector 21 can check the optimum patrol route in the area in which he/she is in charge of patrol on the screen.

### Effects of the Example Embodiment

As described above, in the example embodiment, since the machine learning model for generating the patrol route is constructed from the past information, the inspector 21 can be presented with the patrol route simply by inputting the areas to be patrolled and the time zone. Further, in the example embodiment, since the weather, road information, and events in the patrol area can be used as the training data for the construction of the machine learning model, it is possible to generate the patrol route in consideration of these peripheral information.

### MODIFIED EXAMPLE

Here, modified example of the example embodiment will be described. In the modified example, the patrol route generation unit 12 first estimates important degree of each point, and then generates a route in consideration of the trade-off between the important points to be patrolled and the time constraint. Therefore, in the modified examples, reverse reinforcement learning is performed.

First, as training data, the patrol route for the inspector 21 in the past, map information, and the peripheral information are used. Then, solution of reverse knapsack problem is performed based on the patrol route for the inspector 21 in the past, and the “importance for each point” alpha_ᵢ is estimated as coefficient of the objective function illustrated in Equation 1 below. Phai_ᵢ is a weight set to 1 when the inspector 21 passes the point_i, and set to 0 otherwise. “i” indicates an identification number set at each point.

α₁Ø₁+α₂Ø₂+α₃Ø₃+ [Equation 1]

Then, the result of solving the traveling salesman problem in consideration of “importance for each point” alpha_ᵢ and “representing time constraint” phi_ⱼ is the patrol route of the inspector 21 in the past. Therefore, the objective function illustrated in 2 is learned by reverse reinforcement learning which solves the reverse traveling salesman problem.

$${\sum }_{i} {β}_{i} {α}_{i} + {\sum }_{j} {γ}_{j} {φ}_{j} + … \qquad [ Equation 2 ]$$

In the above Equation 2, phi_ⱼ representing time constraint represents the reciprocal of time required to move between selected points. Further, phi_ᵢᵢ is set for the point i and the point i′, and “j” represents combination “ii′” of the two points numbers. Then, by solving the above-mentioned reverse traveling salesman problem, the coefficients beta_ᵢ and gamma_ⱼ are estimated for each of the “importance for each point” alpha_ᵢ and “representing time constraint” phi_ⱼ.

Therefore, in the modified example, the patrol route generation unit 12 first applies the patrol route for the inspector 21 in the past estimated by the patrol route estimation unit 11, the map information, and the peripheral information to the function (the machine learning model) shown in Equation 1 to estimate the “importance of each point” alpha_ᵢ. Subsequently, the patrol route estimation unit 11 applies the estimated “importance for each point” alpha_ᵢ to the function (the machine learning model) shown in Equation 2 to estimate the coefficients beta_ᵢ and gamma_ᵢ. Then, the patrol route generation unit 12 generates the patrol route by solving the traveling sales problem using the “importance for each point” alpha_ᵢ, the coefficients beta_ᵢ and gamma_ⱼ.

The “importance for each point” alpha_ᵢ may be estimated by a method other than the above-mentioned solution of the reverse knapsack problem. For example, the predicted number of abandoned objects acquired by predictive analysis may be used as the “importance for each point” alpha_ᵢ. In the predictive analysis, the number of abandoned objects is set objective variable and feature value acquired from the location information, the time zone, and the peripheral information is set to explanatory variables.

[Program]

It is sufficient that the program according to the example embodiment be a program that causes a computer to execute steps A1 to A4 illustrated in FIG. 6, and steps B1 to B3 illustrated in FIG. 7. The patrol route generation apparatus 10 and the patrol route generation method according to the example embodiment can be realized by installing this program in the computer and executing this program. In this case, the processor of the computer functions and performs processing as the patrol route estimation unit 11, the patrol route generation unit 12 and the data acquisition unit 13.

In the example embodiment, the data storage unit 14 and the machine learning model storage unit 15 can be realized by storing data files constituting them in a storage device such as a hard disk provided in the computer. Example of computer includes a general-purpose PC, a smartphone, and a tablet-type terminal device.

Also, the program according to the example embodiment may be executed by a computer system constructed by a plurality of computers. In this case, for example, each computer may function as the patrol route estimation unit 11, the patrol route generation unit 12 and the data acquisition unit 13. Further, the data storage unit 14 and the machine learning model storage unit 15 may be constructed on a computer different from the computer that executes the program according to the example embodiment.

[Physical Configuration]

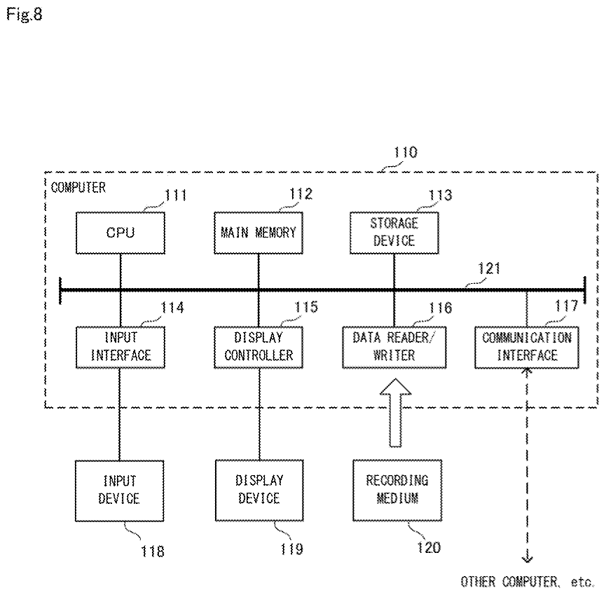

Here, Using FIG. 8, a description is now given of a computer that realizes the patrol route generation apparatus 10 by executing the program according to the example embodiment. FIG. 8 is a block diagram illustrating an example of the computer that realizes the patrol route generation apparatus according to the example embodiment.

As illustrated in FIG. 8, a computer 110 includes a central processing unit (CPU) 111, a main memory 112, a storage device 113, an input interface 114, a display controller 115, a data reader/writer 116, and a communication interface 117. These components are connected via a bus 121 so as to be capable of performing data communication with one another.

Note that the computer 110 may include a graphics processing unit (GPU) or a field-programmable gate array (FPGA) in addition to the CPU 111 or in place of the CPU 111.

The CPU 111 loads the program (codes) in the example embodiment, which is stored in the storage device 113, onto the main memory 112, and performs various computations by executing these codes in a predetermined order. The main memory 112 is typically a volatile storage device such as a dynamic random access memory (DRAM).

Furthermore, the program in the example embodiment is provided in a state such that the program is stored in a computer readable recording medium 120. Note that the program in the example embodiment may also be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading out of the program from the recording medium 120 and the writing of results of processing in the computer 110 to the recording medium 120. The communication interface 117 mediates data transmission between the CPU 111 and other computers.

Furthermore, specific examples of the recording medium 120 include a general-purpose semiconductor storage device such as a CompactFlash (registered trademark, CF) card or a Secure Digital (SD) card, a magnetic recording medium such as a flexible disk, and an optical recording medium such as a compact disk read-only memory (CD-ROM).

Note that the the patrol route generation apparatus in the example embodiment can also be realized by using pieces of hardware corresponding to the respective units, rather than using a computer on which the program is installed. Furthermore, a part of the patrol route generation apparatus 10 may be realized by using the program, and the remaining part of the patrol route generation apparatus 10 may be realized by using hardware.

While a part of or the entirety of the above-described example embodiment can be expressed by (Supplementary note 1) to (Supplementary note 9) described in the following, the invention is not limited to the following description.

(Supplementary Note 1)

A patrol route generation apparatus for generating a patrol route for an inspector who checks abandoned object, including:

a patrol route estimation unit that estimates a patrol route for the inspector in the past, based on a location information indicating a place where the abandoned object was checked in the past and a time information indicating time when the abandoned object was checked in the past,

a patrol route generation unit that generates a patrol route in a preset area and in a preset time zone, based the estimated patrol route for the inspector in the past, the location information indicating the place where the abandoned object was checked in the past and the time information indicating the time when the abandoned object was checked in the past.

(Supplementary Note 2)

The patrol route generation apparatus according to Supplementary note 1, wherein

the patrol route generation unit inputs the area and time zone for which the patrol route is to be generated into a machine learning model to generate the patrol route,

the machine learning model expresses the relationship between the estimated patrol route for the inspector in the past, the location information indicating the place where the abandoned object was checked in the past and the time information indicating the time when the abandoned object was checked in the past, by a branch expression and an objective function.

(Supplementary Note 3)

The patrol route generation apparatus according to Supplementary note 2, wherein

the machine learning model express the relationship further including at least one of weather information indicating the weather of place where the abandoned object was checked in the past, road conditions information indicating condition of road of the place, event information specifying an event that taking place at the place, by the branch expression and the objective function,

the patrol route generation unit inputs the latest weather information, the latest road information, and the latest event information, in addition to the area and time zone for which the patrol route is to be generated.

(Supplementary Note 4)

A patrol route generation method for generating a patrol route for an inspector who checks abandoned object, including:

a patrol route estimation step of estimating a patrol route for the inspector in the past, based on a location information indicating a place where the abandoned object was checked in the past and a time information indicating time when the abandoned object was checked in the past,

a patrol route generation step of generating a patrol route in a preset area and in a preset time zone, based the estimated patrol route for the inspector in the past, the location information indicating the place where the abandoned object was checked in the past and the time information indicating the time when the abandoned object was checked in the past.

(Supplementary Note 5)

The patrol route generation method according to Supplementary note 4, wherein

in the patrol route generation step, inputting the area and time zone for which the patrol route is to be generated into a machine learning model to generate the patrol route,

the machine learning model expresses the relationship between the estimated patrol route for the inspector in the past, the location information indicating the place where the abandoned object was checked in the past and the time information indicating the time when the abandoned object was checked in the past, by a branch expression and an objective function.

(Supplementary Note 6)

The patrol route generation method according to Supplementary note 5, wherein

the machine learning model express the relationship further including at least one of weather information indicating the weather of place where the abandoned object was checked in the past, road conditions information indicating condition of road of the place, event information specifying an event that taking place at the place, by the branch expression and the objective function,

in the patrol route generation step, inputting the latest weather information, the latest road information, and the latest event information, in addition to the area and time zone for which the patrol route is to be generated.

(Supplementary Note 7)

A computer readable recording medium that includes a program for generating a patrol route for an inspector who checks abandoned object using a computer recorded thereon, the program including instructions that cause a computer to carry out:

a patrol route estimation step of estimating a patrol route for the inspector in the past, based on a location information indicating a place where the abandoned object was checked in the past and a time information indicating time when the abandoned object was checked in the past,

a patrol route generation step of generating a patrol route in a preset area and in a preset time zone, based the estimated patrol route for the inspector in the past, the location information indicating the place where the abandoned object was checked in the past and the time information indicating the time when the abandoned object was checked in the past.

(Supplementary Note 8)

The computer readable recording medium according to Supplementary note 7, wherein

in the patrol route generation step, inputting the area and time zone for which the patrol route is to be generated into a machine learning model to generate the patrol route,

the machine learning model expresses the relationship between the estimated patrol route for the inspector in the past, the location information indicating the place where the abandoned object was checked in the past and the time information indicating the time when the abandoned object was checked in the past, by a branch expression and an objective function.

(Supplementary Note 9)

The computer readable recording medium according to Supplementary note 8, wherein

the machine learning model express the relationship further including at least one of weather information indicating the weather of place where the abandoned object was checked in the past, road conditions information indicating condition of road of the place, event information specifying an event that taking place at the place, by the branch expression and the objective function,

in the patrol route generation step, inputting the latest weather information, the latest road information, and the latest event information, in addition to the area and time zone for which the patrol route is to be generated.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

As described above, according to the present invention, it is possible to formulate a patrol route in the work of checking an abandoned object. The present invention is useful for supporting the work of checking an abandoned object.

### LIST OF REFERENCE SIGNS

10 patrol route generation apparatus
11 patrol route estimation unit
12 patrol route generation unit
13 data acquisition unit
14 data storage unit
15 machine learning model storage unit
20 terminal device
21 inspector
110 computer
111 CPU
112 main memory
113 storage device
114 input interface
115 display controller
116 data reader/writer
117 communication interface
118 input apparatus
119 display apparatus
120 recording medium
121 bus

What is claimed is:

1. A patrol route generation apparatus for generating a patrol route for an inspector who checks abandoned object, comprising:
at least one memory storing instructions; and
at least one processor configured to execute the instructions to:
estimate a patrol route for the inspector in the past, based on a location information indicating a place where the abandoned object was checked in the past and a time information indicating time when the abandoned object was checked in the past,
generate a patrol route in a preset area and in a preset time zone, based the estimated patrol route for the inspector in the past, the location information indicating the place where the abandoned object was checked in the past and the time information indicating the time when the abandoned object was checked in the past.

2. The patrol route generation apparatus according to claim 1,
wherein, further at least one processor configured to execute the instructions to:
input the area and time zone for which the patrol route is to be generated into a machine learning model to generate the patrol route,
the machine learning model expresses the relationship between the estimated patrol route for the inspector in the past, the location information indicating the place where the abandoned object was checked in the past and the time information indicating the time when the abandoned object was checked in the past, by a branch expression and an objective function.

3. The patrol route generation apparatus according to claim 2, wherein
the machine learning model express the relationship further including at least one of weather information indicating the weather of place where the abandoned object was checked in the past, road conditions information indicating condition of road of the place, event information specifying an event that taking place at the place, by the branch expression and the objective function,
further at least one processor configured to execute the instructions to: input the latest weather information, the latest road information, and the latest event information, in addition to the area and time zone for which the patrol route is to be generated.

4. A patrol route generation method for generating a patrol route for an inspector who checks abandoned object, comprising:
estimating a patrol route for the inspector in the past, based on a location information indicating a place where the abandoned object was checked in the past and a time information indicating time when the abandoned object was checked in the past,
generating a patrol route in a preset area and in a preset time zone, based the estimated patrol route for the inspector in the past, the location information indicating the place where the abandoned object was checked in the past and the time information indicating the time when the abandoned object was checked in the past.

5. The patrol route generation method according to claim 4, wherein
in the patrol route generating, inputting the area and time zone for which the patrol route is to be generated into a machine learning model to generate the patrol route,
the machine learning model expresses the relationship between the estimated patrol route for the inspector in the past, the location information indicating the place where the abandoned object was checked in the past and the time information indicating the time when the abandoned object was checked in the past, by a branch expression and an objective function.

6. The patrol route generation method according to claim 5, wherein
the machine learning model express the relationship further including at least one of weather information indicating the weather of place where the abandoned object was checked in the past, road conditions information indicating condition of road of the place, event information specifying an event that taking place at the place, by the branch expression and the objective function,
in the patrol route generating, inputting the latest weather information, the latest road information, and the latest event information, in addition to the area and time zone for which the patrol route is to be generated.

7. A non-transitory computer readable recording medium that includes a program for generating a patrol route for an inspector who checks abandoned object using a computer recorded thereon, the program including instructions that cause a computer to carry out:
estimating a patrol route for the inspector in the past, based on a location information indicating a place where the abandoned object was checked in the past and a time information indicating time when the abandoned object was checked in the past,
generating a patrol route in a preset area and in a preset time zone, based the estimated patrol route for the inspector in the past, the location information indicating the place where the abandoned object was checked in the past and the time information indicating the time when the abandoned object was checked in the past.

8. The non-transitory computer readable recording medium according to claim 7, wherein
in the patrol route generating, inputting the area and time zone for which the patrol route is to be generated into a machine learning model to generate the patrol route,
the machine learning model expresses the relationship between the estimated patrol route for the inspector in the past, the location information indicating the place where the abandoned object was checked in the past and the time information indicating the time when the abandoned object was checked in the past, by a branch expression and an objective function.

9. The non-transitory computer readable recording medium according to claim 8, wherein
the machine learning model express the relationship further including at least one of weather information indicating the weather of place where the abandoned object was checked in the past, road conditions information indicating condition of road of the place, event information specifying an event that taking place at the place, by the branch expression and the objective function,
in the patrol route generating, inputting the latest weather information, the latest road information, and the latest event information, in addition to the area and time zone for which the patrol route is to be generated.
